(19) United States
(12) Patent Application Publication
(10) Pub. No.: US 2026/0368533 A1
(43) Pub. Date: Nov. 19, 2026

(54) METHOD AND APPARATUS FOR RECOGNIZING MALICIOUS TRAFFIC BASED ON SPATIAL-TEMPORAL ATTENTION MECHANISM

(71) Applicants: TSINGHUA UNIVERSITY, BEIJING (CN); CHINA TELECOM CYBERSECURITY TECHNOLOGY CO., LTD., SUZHOU (CN)

(72) Inventors: KE XU, BEIJING (CN); FAN LI, BEIJING (CN); YI ZHAO, BEIJING (CN); QI LI, BEIJING (CN); LIYUAN CHANG, SUZHOU (CN); MIN ZHU, BEIJING (CN)

(21) Appl. No.: 19/675,498

(22) Filed: May 13, 2026

(30) Foreign Application Priority Data
May 13, 2025 (CN) 2025106085143

(51) Int. Cl. G06N 3/0895; G06N 3/045

(52) U.S. Cl. CPC G06N 3/0895; G06N 3/045

(57) ABSTRACT

A method and for recognizing malicious traffic based on a spatial-temporal attention mechanism includes, for each flow in a flow training data set, calculating a spatial-temporal feature of the flow; obtaining a spatial-temporal feature combination of a source and a destination neighbor flow of the flow, and calculating a neighbor embedding of the flow; inputting the spatial-temporal feature and the neighbor embedding into a discriminator to calculate a malicious degree score; calculating a difference between the malicious degree score and a flow label of the flow, obtaining trained neural network models; and calculating a malicious degree score of a flow to be detected by a trained discriminator, and comparing the malicious degree score of the flow to be detected with a threshold to determine whether the flow to be detected is a malicious flow based on a numerical comparison result.

### CROSS-REFERENCE TO RELATED PATENT APPLICATION

This application claims priority to and benefits of Chinese Patent Application Serial No. 2025106085143 filed the State Intellectual Property Office of P. R. China on May 13, 2025, the entire content of which is incorporated herein by reference.

### FIELD OF THE DISCLOSURE

The disclosure relates to the field of next-generation Internet application security, cyberspace security and artificial intelligence technologies, mainly applied to concealed malicious traffic identification technologies, and particularly relates to a method and an apparatus for recognizing malicious traffic based on a spatial-temporal attention mechanism.

### BACKGROUND OF THE DISCLOSURE

In recent years, methods for graph-based malicious traffic recognition emerge. In such methods, traffic is represented as a network topology graph in which an address serves as a node and a flow serves as an edge, and a model of a graph convolutional neural network is employed to recognize malicious traffic. A graph is a data structure combined by a set of nodes and a set of edges representing a connection relations between the nodes. Two nodes connected by an edge are defined as neighboring nodes to each other. By analogy with a convolution definition in a field of image recognition, the graph convolutional neural network defines convolution operations in the graph as aggregation of features of the neighboring nodes, such that the model comprehensively learns node features and spatial features of a topological graph to achieve an improved learning effect.

In the graph convolutional neural network, there are multiple calculation models for aggregation coefficients used in aggregating the features of the neighboring nodes. In a conventional model of the graph convolutional neural network, it is considered that the more nodes one node is connected to, the weaker an influence of the node on each neighboring node, and also the weaker influence of each neighboring node on the node. Therefore, the aggregation coefficient in the model is calculated according to a degree of two associated nodes, in which a large degree corresponds to a small aggregation coefficient. In a model of a relational graph convolutional neural network, an aggregation coefficient is assigned based on a type of an associated edge, in which the scarcer the type of the edge connected to a current node, the larger the corresponding aggregation coefficient.

The existing models mainly infer an influence of neighboring nodes on the current node based on a static graph topological structure, but have a limited capability in characterizing scenarios with time-varying topologies. In addition, isomorphism phenomena exist in numerous real-world networks, namely, similar nodes are more closely associated. For example, in a traffic interaction network, neighboring flows (from homologous or identical destination addresses) with approximate occurrence time and similar traffic to the current flow generally originate from a same session and serve a same objective. When recognizing the type of the current flow, such similar neighboring flows provide more valuable information than other neighboring flows, but existing models of the graph convolutional neural network are incapable of capturing such semantic correlation.

### SUMMARY OF THE DISCLOSURE

A first aspect of the disclosure provides a method for recognizing malicious traffic based on a spatial-temporal attention mechanism, including: for each flow in a flow training data set, calculating a spatial-temporal feature of the flow in a flow training data set by employing an initialized encoder;
obtaining a spatial-temporal feature combination of a source and a destination neighbor flow of the flow, and calculating a neighbor embedding of the flow by employing an attention network;
inputting the spatial-temporal feature and the neighbor embedding into a discriminator to calculate a malicious degree score;
calculating a difference between the malicious degree score and a flow label of the flow, calculating a gradient of parameters of the encoder, the attention network and the discriminator relative to the difference, updating the parameters of neural networks to obtain trained neural network models corresponding to the encoder, the attention network and the discriminator respectively, and recording a threshold that enables the flow training data set to achieve a balance between an optimal recall rate and a false positive rate, in which the neural networks comprise the encoder, the attention network and the discriminator; and
calculating a malicious degree score of a flow to be detected by the trained neural network model of the discriminator, and comparing the malicious degree score of the flow to be detected with the threshold to determine whether the flow to be detected is a malicious flow based on a numerical comparison result.

A second aspect of the disclosure provides an electronic device, including: one or more processors, and a memory for storing instructions executable by the one or more processors. The one or more processors are configured to execute the method in the first aspect.

A third aspect of the disclosure provides a non-transitory computer-readable storage medium for storing computer instructions, in which the computer instructions are configured to cause a computer to execute the method in the first aspect.

### BRIEF DESCRIPTION OF THE DRAWINGS

The above and/or additional aspects and advantages of the disclosure will become apparent and more readily appreciated from the following descriptions of embodiments made with reference to the accompanying drawings.

FIG. 1 is a flow chart illustrating a method for recognizing malicious traffic based on a spatial-temporal attention mechanism according to embodiments of the disclosure.

FIG. 2 is a block diagram illustrating an apparatus for recognizing malicious traffic based on a spatial-temporal attention mechanism according to embodiments of the disclosure.

### DETAILED DESCRIPTION OF THE EXEMPLARY EMBODIMENTS

It should be noted that embodiments in the disclosure and features in the embodiments may be combined with each other without conflict. Description is made in detail below to the disclosure with reference to the accompanying drawings in combination with embodiments.

For the skilled in the art better understanding the solution of the disclosure, description is made below clearly and completely to the technical solution in embodiments of the disclosure with reference to the accompanying drawings in embodiments of the disclosure. Obviously, described embodiments is only some of embodiments of the disclosure, but not all the embodiments. Based on embodiments in the disclosure, all other embodiments obtained by the skilled in the art without creative work should belong to the scope of protection of the disclosure.

Description is made below to a method and an apparatus for recognizing malicious traffic based on a spatial-temporal attention mechanism in embodiments of the disclosure with reference to the accompanying drawings.

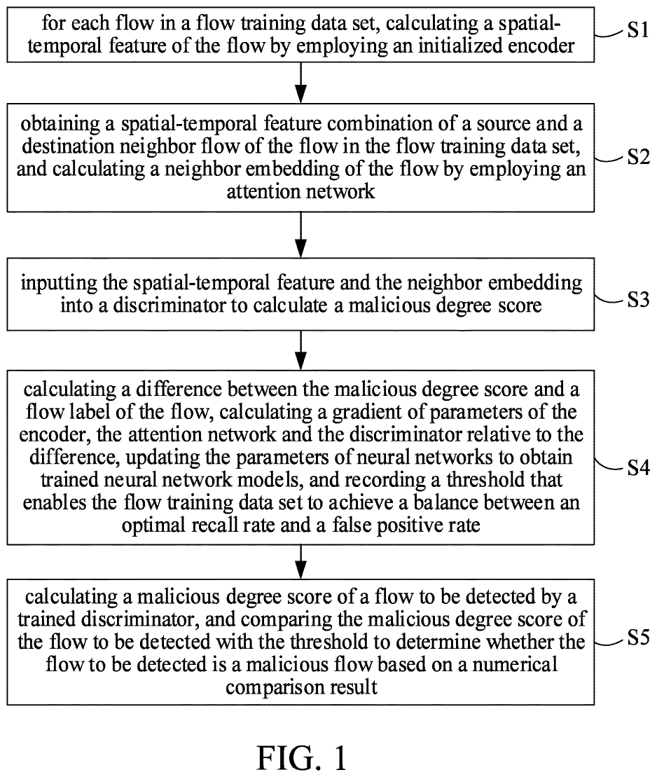

FIG. 1 is a flow chart illustrating a method for recognizing malicious traffic based on a spatial-temporal attention mechanism according to embodiments of the disclosure. As illustrated in FIG. 1, the method includes the following.

At block S1, for each flow in a flow training data set, a spatial-temporal feature of the flow is calculated by employing an initialized encoder.

Firstly, an encoder is initialized. The encoder includes a time encoder T(·) and a traffic pattern encoder P(·). Both of the time encoder T(·) and the traffic pattern encoder P(·) employ a first neural network model. An input of the time encoder T(·) is a flow timestamp with a dimension 1, and an output of the time encoder T(·) is a flow timestamp with a dimension D. An input of the traffic pattern encoder P(·) is an M-dimensional statistical feature, and an output of the traffic pattern encoder P(·) is a D-dimensional statistical feature. A detailed network and a type of activation functions depend on a detailed application scenario. Parameters of the first neural network are initialized by a following random initialization way. For a parameter matrix A^{(l)} with l layers (l>1), elements of the parameter matrix obey a Gaussian distribution with a mean of 0 and a variance of \sqrt{2/nₗ₋₁}, where nₗ₋₁ is a number of neurons in a (l−1)^{-th} layer, and parameters in the first layer are initialized to a random real matrix which obeys a standard normal distribution.

Secondly, a % of data in the flow training data set is taken as a training set and remaining of the data is taken as a test set to ensure that the training set and the test set do not intersect. For example, first a % of the flow training data set may be taken as the training set and the remaining of the data is taken as the test set.

Then, the spatial-temporal feature of the flow in the flow training data set is calculated. It is assumed that a time stamp of an i^{-th} flow is t⁽ⁱ⁾ and a statistical feature of the i^{-th} flow is w⁽ⁱ⁾∈ [symbol] ^{m} The time stamp t⁽ⁱ⁾ is inputted into the time encoder to obtain a time encoding τ⁽ⁱ⁾=T(t⁽ⁱ⁾), and the statistical feature w⁽ⁱ⁾ is inputted into the traffic pattern encoder to obtain a traffic pattern encoding ω⁽ⁱ⁾=P(w⁽ⁱ⁾). The time encoding τ⁽ⁱ⁾ and the traffic pattern encoding ω⁽ⁱ⁾ are merged to obtain the spatial-temporal feature v⁽ⁱ⁾=(τ⁽ⁱ⁾∥ω⁽ⁱ⁾) of the i^{-th} flow, where ∥ represents concatenating two vectors end to end into one vector.

At block S2, a spatial-temporal feature combination of a source and a destination neighbor flow of the flow is obtained, and a neighbor embedding of the flow is calculated by employing an attention network.

Firstly, a neighbor flow set is determined for each flow in the flow training data set. It is assumed that a source address of the i^{-th} flow is s⁽ⁱ⁾ and a destination address of the i^{-th} flow is d⁽ⁱ⁾. It is determined that a source neighbor

$${𝒩}_{s}^{( i )}$$

of the i^{-th} flow is an index set of all flows with source addresses being s⁽ⁱ⁾, and a destination neighbor

$${𝒩}_{d}^{( i )}$$

of the i^{-th} flow is an index set of all flows with destination addresses being d⁽ⁱ⁾.

Secondly, the attention network is initialized. A query vector Q of the attention network Att(Q,K,V) is the spatial-temporal feature v⁽ⁱ⁾∈ [symbol] ^{2d} of the i-th flow, both a key vector K and a value vector V are the spatial-temporal feature combination of the source and the destination neighbor flow of the i^{-th} flow, and the spatial-temporal feature combination is represented by

$${H}^{( i )} = {[ {v}^{( j )} ]}_{j ∈ Sample ( {𝒩}_{s}^{( i )} , k ) ⋃ Sample ( {𝒩}_{d}^{( i )} , k )}^{T} ∈ {ℝ}^{2 k \times 2 d} ,$$

where Sample(S,k) represents extracting K elements randomly from a set S. An output of the attention network is an aggregated neighbor embedding u⁽ⁱ⁾, with a dimension of c. Attention parameters, the network and the type of the activation function depend on a detailed application scenario. The attention network employs a second neural network model, and parameters of the second neural network are initialized by the following random initialization way. For a parameter matrix M^{(l}^{ₘ}⁾ with lₘ layers (lₘ>1), elements of the parameter matrix obey a Gaussian distribution with a mean of 0 and a variance of \sqrt{2/mₗ_{ₘ}₋₁}, where mₗ_{ₘ}₋₁ is a number of neurons in a (lₘ−1)^{-th} layer, and parameters in the first layer are initialized to a random real matrix which obeys a standard normal distribution.

Then, a neighbor embedding of the flow in the flow training data set is calculated. A neighbor embedding of the i^{-th} flow is calculated by:

u⁽ⁱ⁾=Att(v⁽ⁱ⁾,H⁽ⁱ⁾,H⁽ⁱ⁾),
where H⁽ⁱ⁾ represents a key vector K and a value vector V.

At block S3, the spatial-temporal feature and the neighbor embedding are inputted into a discriminator to calculate a malicious degree score.

At block S4, a difference between the malicious degree score and a flow label of the flow is calculated, a gradient of parameters of the encoder, the attention network and the discriminator relative to the difference is calculated, a parameter of a neural network is updated to obtain trained neural network models, and a threshold that enables the flow training data set to achieve a balance between an optimal recall rate and a false positive rate is recorded.

Firstly, the discriminator is initialized. The discriminator D(·) employs a third neural network model. The spatial-temporal feature v⁽ⁱ⁾ and the neighbor embedding u⁽ⁱ⁾ of the i^{-th} flow, with a dimension of 2d+c, are inputted to the discriminator to output a malicious degree score of the i^{-th} flow, with a dimension of 1, and a range of [0,1]. A detailed network and the type of the activation function depend on a detailed application scenario. Parameters of the third neural network are initialized by the following random initialization way. For a parameter matrix R^{(l}^{ᵣ}⁾ with lᵣ layers (lᵣ>1), elements of the parameter matrix obey a Gaussian distribution with a mean of 0 and a variance of \sqrt{2/rₗ_{ᵣ}₋₁}, where rₗ_{ᵣ}₋₁ is a number of neurons in a (lᵣ−1)^{-th} layer, and parameters in the first layer are initialized to a random real matrix which obeys a standard normal distribution.

Secondly, the malicious degree score of the flow in the flow training data set is calculated by:

score⁽ⁱ⁾=D(v⁽ⁱ⁾∥u⁽ⁱ⁾).

Then, for each flow in the flow training data set, the difference between the malicious degree score and a flow label (a label of a malicious flow is 1, and a label of a benign flow is 0) is calculated, and the gradient of the difference relative to the parameters of the encoder, the attention network and the discriminator is calculated. Then, the parameters of the neural networks are updated by back propagation, and repeated for several rounds until the neural network models converge, and the threshold for balancing the optimal recall rate and the false positive rate is recorded. The threshold is calculated by:

threshold=argmax(TPR·(1−FPR)),

where TPR represents a recall rate of the model in a series of thresholds, and FPR represents a false positive rate of the model in the series of thresholds.

At block S5, a malicious degree score of a flow to be detected is calculated by a trained discriminator, and the malicious degree score of the flow to be detected is compared with the threshold to determine whether the flow to be detected is a malicious flow based on a numerical comparison result.

In detail, the trained first neural network model, the trained second neural network model and the trained third neural network model are deployed in a defense system of a network environment to recognize malicious traffic.

Firstly, in the detection stage, the spatial-temporal feature v⁽ⁱ⁾ of the i-th flow to be detected is calculated by using the trained time encoder T(·) and the trained traffic pattern encoder P(·).

Secondly, the source neighbor

$${𝒩}_{s}^{( i )} )$$

and the destination neighbor

$${𝒩}_{d}^{( i )}$$

of the i^{-th} flow to be detected in the flow training data set are queried, and the neighbor embedding u u⁽ⁱ⁾ of the i^{-th} flow is calculated by employing the trained attention network Att(Q,K,V).

Then, the malicious degree score score⁽ⁱ⁾ of the flow to be detected is calculated by employing the trained discriminator D(·). In a case that the malicious degree score outputted by the discriminator is greater than the threshold obtained during model training, it is determined that the flow is malicious and an alarm message is sent to a network manager in time; Otherwise, it is determined that the flow is a normal flow.

In conclusion, the disclosure proposes to use the spatial-temporal attention mechanism to aggregate neighbor flow information, which is different from a convention graph neural network method of calculating an aggregation coefficient based on static topological features of nodes. The neural network based on a spatial-temporal attention graph takes into account time and traffic pattern similarity of neighbor flows with the current flow simultaneously, to give a higher aggregation coefficient to a neighbor flow which is more similar to the current flow, thus improving information contribution of similar neighbors to the current flow. In terms of process, the disclosure includes two stages, i.e., a training stage and a detection stage. In the training stage, the time stamp and traffic pattern of each flow in the training set are input into the encoder to calculate the spatial-temporal feature of the flow. Then, based on a relationship of the same source or the same destination address of the flows, a neighbor flow set is determined for each flow, and the spatial-temporal feature of the current flow and the spatial-temporal feature of the neighbor flow are combined and input into the attention network to obtain the neighbor embedding of the current flow. Finally, the spatial-temporal feature of the current flow are combined with the neighbor embedding and input into the discriminator, to obtain the malicious degree score of the current flow. The encoder, the discriminator and the attention network are trained in combination with the flow label (whether the current flow is malicious or not). In the detection stage, the encoder is used to calculate the spatial-temporal feature of the flow to be detected, and the neighbor flow in the flow training data set is queried. The attention network is used to calculate the neighbor embedding of the flow to be detected, and then in combination with the spatial-temporal feature of the flow to be detected, the discriminator is used to determine whether the stream is a malicious stream. The core of the disclosure is to integrate the time and the spatial feature of the flow and to allocate the aggregation weight by using the attention mechanism, to capture a semantic relevance in a traffic interaction network, thus improving a graph learning effect and realizing more accurate and efficient malicious traffic recognition.

According to the method for recognizing the malicious traffic based on the spatial-temporal attention mechanism in the embodiments of the disclosure, a problem that the spatial-temporal correlation between flows is not fully utilized in the graph-based malicious traffic recognition is solved, thus improving recognition effect of a hidden malicious traffic. The spatial-temporal attention mechanism considers the time and traffic pattern similarity of the neighbor flow simultaneously with the current flow, and provide a higher aggregation coefficient for the neighbor flow that is more similar to the current flow. In this way, the information contribution of similar neighbors to the current flow is improved, the model may better capture the semantic correlation between flows on the traffic interaction network with time-varying topology and strong homogeneity, the graph-convolution neural network may aggregate neighbor information more effectively, features of malicious traffic and normal traffic are more separated in the feature space, thus improving the accuracy and robustness of model recognition.

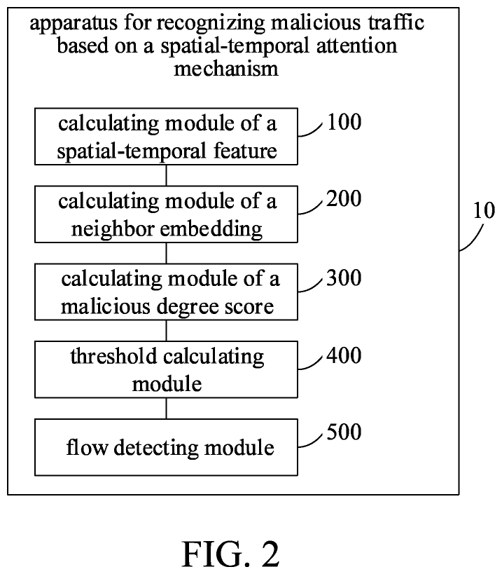

To realize the above embodiments, as illustrated in FIG. 2, an apparatus 10 for recognizing malicious traffic based on a spatial-temporal attention mechanism is further provided in embodiments. The apparatus 10 includes:
a calculating module 100 of a spatial-temporal feature, configured to, for each flow in a flow training data set, calculate a spatial-temporal feature of the flow by employing an initialized encoder;
a calculating module 200 of a neighbor embedding, configured to obtain a spatial-temporal feature combination of a source and a destination neighbor flow of the flow, and calculate a neighbor embedding of the flow by employing an attention network;
a calculating module 300 of a malicious degree score, configured to input the spatial-temporal feature and the neighbor embedding into a discriminator to calculate the malicious degree score;
a threshold calculating module 400, configured to calculate a difference between the malicious degree score and a flow label of the flow, calculate a gradient of parameters of the encoder, the attention network and the discriminator relative to the difference, update the parameters of neural networks to obtain trained neural network models, and record a threshold that enables the flow training data set to achieve a balance between an optimal recall rate and a false positive rate; and
a flow detecting module 500, configured to calculate a malicious degree score of a flow to be detected by a trained discriminator, and compare the malicious degree score of the flow to be detected with the threshold to determine whether the flow to be detected is a malicious flow based on a numerical comparison result.

Further, the calculating module 100 of the spatial-temporal feature is also configured to:
initialize an encoder, in which the encoder includes a time encoder T(·) and a traffic pattern encoder P(·), and the encoder employs a first neural network model;
construct the flow training data set; and
preset that a time stamp of an i^{-th} flow in the flow training data set is t⁽ⁱ⁾ and a statistical feature of the i^{-th} flow is w⁽ⁱ⁾∈ [symbol] ^{m}, input the time stamp t⁽ⁱ⁾ into the time encoder to obtain a time encoding τ⁽ⁱ⁾=T(t⁽ⁱ⁾), input the statistical feature w⁽ⁱ⁾ into the traffic pattern encoder to obtain a traffic pattern encoding ω⁽ⁱ⁾=P(w⁽ⁱ⁾), and merge the time encoding τ⁽ⁱ⁾ and the traffic pattern encoding ω⁽ⁱ⁾ to obtain the spatial-temporal feature v⁽ⁱ⁾=(τ⁽ⁱ⁾∥ω⁽ⁱ⁾), where ∥ represents concatenating two vectors end to end into one vector.

Further, the calculating module 200 of the neighbor embedding is also configured to:
preset that a source address of the i^{-th} flow in the flow training data set is s⁽ⁱ⁾ and a destination address of the i^{-th} flow is d⁽ⁱ⁾, and determine that a source neighbor

$${𝒩}_{s}^{( i )}$$

of the i^{-th} flow is an index set of all flows with source addresses being s⁽ⁱ⁾, and a destination neighbor

$${𝒩}_{d}^{( i )}$$

of the i^{-th} flow is an index set of all flows with destination addresses being d⁽ⁱ⁾;
initialize the attention network, in which the attention network employs a second neural network model, a query vector Q of the attention network Att(Q,K,V) is the spatial-temporal feature v⁽ⁱ⁾∈ [symbol] ^{2d} of the i^{-th} flow, both a key vector K and a value vector V are the spatial-temporal feature combination of the source and the destination neighbor flow of the i^{-th} flow, and the spatial-temporal feature combination is represented by

$${H}^{( i )} = {[ {v}^{( j )} ]}_{j ∈ Sample ( {𝒩}_{s}^{( i )} , k ) ⋃ Sample ( {𝒩}_{d}^{( i )} , k )}^{T} ∈ {ℝ}^{2 k \times 2 d} ,$$

where Sample (S,k) represents extracting K elements randomly from a set S, and an output of the attention network is an aggregated neighbor embedding u⁽ⁱ⁾; and
calculate a neighbor embedding of the i^{-th} flow in the flow training data set by:

u⁽ⁱ⁾=Att(v⁽ⁱ⁾,H⁽ⁱ⁾,H⁽ⁱ⁾),

where u⁽ⁱ⁾ represents the neighbor embedding of the i^{-th} flow.

Further, the calculating module 300 of the malicious degree score is also configured to:
initialize the discriminator D(·), in which the discriminator D(·) employs a third neural network model; and
input the spatial-temporal feature v⁽ⁱ⁾ and the neighbor embedding u⁽ⁱ⁾ of the i^{-th} flow to the discriminator D(·) to output a malicious degree score of the i-th flow in the flow training data set.

Further, the threshold is calculated by:

threshold=argmax(TPR·(1−FPR)),

where TPR represents a recall rate of the model in a series of thresholds, and FPR represents a false positive rate of the model in the series of thresholds.

According to the apparatus for recognizing the malicious traffic based on the spatial-temporal attention mechanism in the embodiments of the disclosure, a problem that the spatial-temporal correlation between flows is not fully utilized in the graph-based malicious traffic recognition is solved, thus improving recognition effect of a hidden malicious traffic. The spatial-temporal attention mechanism considers time and traffic pattern similarity of the neighbor flow simultaneously, and provide a higher aggregation coefficient for the neighbor flow that is more similar to the current flow. In this way, the information contribution of similar neighbors to the current flow is improved, the model may better capture the semantic correlation between flows on the traffic interaction network with time-varying topology and strong homogeneity, the graph convolution neural network may aggregate neighbor information more effectively, features of malicious traffic and normal traffic are more separated in the feature space, thus improving the accuracy and robustness of model recognition.

In the description of the disclosure, reference throughout this specification to “an embodiment,” “some embodiments,” “an example,” “a detailed example,” or “some examples,” means that a particular feature, structure, material, or feature described in connection with the embodiment or example is included in at least one embodiment or example of the disclosure. The appearances of the phrases in various places throughout this specification are not necessarily referring to the same embodiment or example of the disclosure. Furthermore, the particular features, structures, materials, or features may be combined in any suitable manner in one or more embodiments or examples. In addition, without a contradiction, different embodiments or examples and the features of different embodiments or examples in the specification may be combined by those skilled in the art.

In addition, terms such as “first” and “second” are used herein for purposes of description and are not intended to indicate or imply relative importance or implicitly indicate the number of indicated technical features. Furthermore, the feature defined with “first” and “second” may include at least one feature distinctly or implicitly. In the description of the disclosure, “a plurality of” means at least two, such as two, three, unless specified otherwise.

What is claimed is:

1. A method for recognizing malicious traffic based on a spatial-temporal attention mechanism, comprising:
for each flow in the flow training data set, calculating a spatial-temporal feature of the flow by employing an initialized encoder;
obtaining a spatial-temporal feature combination of a source and a destination neighbor flow of the flow, and calculating a neighbor embedding of the flow by employing an attention network;
inputting the spatial-temporal feature and the neighbor embedding into a discriminator to calculate a malicious degree score;
calculating a difference between the malicious degree score and a flow label of the flow, calculating a gradient of parameters of the encoder, the attention network and the discriminator relative to the difference, updating the parameters of neural networks to obtain trained neural network models corresponding to the encoder, the attention network and the discriminator respectively, and recording a threshold that enables the flow training data set to achieve a balance between an optimal recall rate and a false positive rate, wherein the neural networks comprise the encoder, the attention network and the discriminator; and
calculating a malicious degree score of a flow to be detected by the trained neural network model of the discriminator, and comparing the malicious degree score of the flow to be detected with the threshold to determine whether the flow to be detected is a malicious flow based on a numerical comparison result.

2. The method of claim 1, wherein calculating the spatial-temporal feature of the flow by employing the initialized encoder comprises:
initializing an encoder, wherein the encoder comprises a time encoder T(·) and a traffic pattern encoder P(·), and the encoder employs a first neural network model;
constructing the flow training data set; and
presetting that a time stamp of an i^{-th} flow in the flow training data set is t⁽ⁱ⁾ and a statistical feature of the i^{-th} flow is w⁽ⁱ⁾∈ [symbol] ^{m}, inputting the time stamp t⁽ⁱ⁾ into the time encoder to obtain a time encoding τ⁽ⁱ⁾=T(t⁽ⁱ⁾), inputting the statistical feature w⁽ⁱ⁾ into the traffic pattern encoder to obtain a traffic pattern encoding ω⁽ⁱ⁾=P(w⁽ⁱ⁾), and merging the time encoding τ⁽ⁱ⁾ and the traffic pattern encoding ω⁽ⁱ⁾ to obtain the spatial-temporal feature v⁽ⁱ⁾=(τ⁽ⁱ⁾∥ω⁽ⁱ⁾), where ∥ represents concatenating two vectors end to end into one vector.

3. The method of claim 2, wherein obtaining the spatial-temporal feature combination of the source and the destination neighbor flow of the flow, and calculating the neighbor embedding of the flow by employing the attention network comprise:
presetting that a source address of the i^{-th} flow in the flow training data set is s⁽ⁱ⁾ and a destination address of the i^{-th} flow is d⁽ⁱ⁾, and determining that a source neighbor
$${𝒩}_{s}^{( i )}$$
of the i^{-th} flow is an index set of all flows with source addresses being s⁽ⁱ⁾, and a destination neighbor
$${𝒩}_{d}^{( i )}$$
of the i^{-th} flow is an index set of all flows with destination addresses being d⁽ⁱ⁾;
initializing the attention network, wherein the attention network employs a second neural network model, a query vector Q of the attention network Att(Q,K,V) is the spatial-temporal feature v⁽ⁱ⁾∈ [symbol] ^{2d} of the i^{-th} flow, both a key vector K and a value vector V are vectors of the spatial-temporal feature combination of the source and the destination neighbor flow of the i^{-th} flow respectively, and the spatial-temporal feature combination is represented by
$${H}^{( i )} = {[ {v}^{( j )} ]}_{j ∈ Sample ( {𝒩}_{s}^{( i )} , k ) ⋃ Sample ( {𝒩}_{d}^{( i )} , k )}^{T} ∈ {ℝ}^{2 k \times 2 d} ,$$
where Sample(S,k) represents extracting K elements randomly from a set S, and an output of the attention network is an aggregated neighbor embedding u⁽ⁱ⁾, and
calculate a neighbor embedding of the i^{-th} flow in the flow training data set by:
u⁽ⁱ⁾=Att(v⁽ⁱ⁾,H⁽ⁱ⁾,H⁽ⁱ⁾),
where u⁽ⁱ⁾ represents the neighbor embedding of the i^{-th} flow.

4. The method of claim 3, wherein inputting the spatial-temporal feature and the neighbor embedding into the discriminator to calculate the malicious degree score comprises:
initializing the discriminator D(·), wherein the discriminator D(·) employs a third neural network model; and
inputting the spatial-temporal feature v⁽ⁱ⁾ and the neighbor embedding u⁽ⁱ⁾ of the i^{-th} flow to the discriminator D(·) to output a malicious degree score of the i^{-th} flow in the flow training data set.

5. The method of claim 1, wherein the threshold is calculated by:
threshold=argmax(TPR·(1−FPR)),
where TPR represents a recall rate of the trained neural network model of the discriminator in a series of thresholds, and FPR represents a false positive rate of the trained neural network model of the discriminator in the series of thresholds.

6. An electronic device, comprising:
one or more processors; and
a memory for storing instructions executable by the one or more processors,
wherein the one or more processors are configured to:
for each flow in the flow training data set, calculate a spatial-temporal feature of the flow by employing an initialized encoder;
obtain a spatial-temporal feature combination of a source and a destination neighbor flow of the flow, and calculate a neighbor embedding of the flow by employing an attention network;
input the spatial-temporal feature and the neighbor embedding into a discriminator to calculate the malicious degree score;
calculate a difference between the malicious degree score and a flow label of the flow, calculate a gradient of parameters of the encoder, the attention network and the discriminator relative to the difference, update the parameters of neural networks to obtain trained neural network models corresponding to the encoder, the attention network and the discriminator respectively, and record a threshold that enables the flow training data set to achieve a balance between an optimal recall rate and a false positive rate, wherein the neural networks comprise the encoder, the attention network and the discriminator; and
calculate a malicious degree score of a flow to be detected by the trained neural network model of the discriminator, and compare the malicious degree score of the flow to be detected with the threshold to determine whether the flow to be detected is a malicious flow based on a numerical comparison result.

7. The electronic device of claim 6, wherein the one or more processors are further configured to:
initialize an encoder, wherein the encoder comprises a time encoder T(·) and a traffic pattern encoder P(·), and the encoder employs a first neural network model;
construct the flow training data set; and
preset that a time stamp of an i^{-th} flow in the flow training data set is t⁽ⁱ⁾ and a statistical feature of the i^{-th} flow is w⁽ⁱ⁾∈ [symbol] ^{m}, input the time stamp t⁽ⁱ⁾ into the time encoder to obtain a time encoding τ⁽ⁱ⁾=T(t⁽ⁱ⁾), input the statistical feature w⁽ⁱ⁾ into the traffic pattern encoder to obtain a traffic pattern encoding ω⁽ⁱ⁾=P(w⁽ⁱ⁾), and merge the time encoding τ⁽ⁱ⁾ and the traffic pattern encoding ω⁽ⁱ⁾ to obtain the spatial-temporal feature v⁽ⁱ⁾=(τ⁽ⁱ⁾∥ω⁽ⁱ⁾), where ∥ represents concatenating two vectors end to end into one vector.

8. The electronic device of claim 7, wherein the one or more processors are further configured to:
preset that a source address of the i^{-th} flow in the flow training data set is s⁽ⁱ⁾ and a destination address of the i^{-th} flow is d⁽ⁱ⁾, and determine that a source neighbor
$${𝒩}_{s}^{( i )}$$
of the i^{th} flow is an index set of all flows with source addresses being s⁽ⁱ⁾, and a destination neighbor
$${𝒩}_{d}^{( i )}$$
of the i^{-th} flow is an index set of all flows with destination addresses being d⁽ⁱ⁾;
initialize the attention network, wherein the attention network employs a second neural network model, a query vector Q of the attention network Att(Q,K,V) is the spatial-temporal feature v⁽ⁱ⁾∈ [symbol] ^{2d} of the i^{-th} flow, both a key vector K and a value vector V are vectors of the spatial-temporal feature combination of the source and the destination neighbor flow of the i-th flow respectively, and the spatial-temporal feature combination is represented by
$${H}^{( i )} = {[ {v}^{( j )} ]}_{j ∈ Sample ( {𝒩}_{s}^{( i )} , k ) ⋃ Sample ( {𝒩}_{d}^{( i )} , k )}^{T} ∈ {ℝ}^{2 k \times 2 d} ,$$
where Sample(S,k) represents extracting K elements randomly from a set S, and an output of the attention network is an aggregated neighbor embedding u⁽ⁱ⁾, and
calculate a neighbor embedding of the i^{-th} flow in the flow training data set by:
u⁽ⁱ⁾=Att(v⁽ⁱ⁾,H⁽ⁱ⁾,H⁽ⁱ⁾),
where u⁽ⁱ⁾ represents the neighbor embedding of the i^{-th} flow.

9. The electronic device of claim 8, wherein the one or more processors are further configured to:
initialize the discriminator D(·), wherein the discriminator D(·) employs a third neural network model; and
input the spatial-temporal feature v⁽ⁱ⁾ and the neighbor embedding u⁽ⁱ⁾ of the i^{-th} flow to the discriminator D(·) to output a malicious degree score of the i^{-th} flow in the flow training data set.

10. The electronic device of claim 6, wherein the threshold is calculated by:
threshold=argmax(TPR·(1−FPR)),
where TPR represents a recall rate of the trained neural network model of the discriminator in a series of thresholds, and FPR represents a false positive rate of the trained neural network model of the discriminator in the series of thresholds.

11. A non-transitory computer-readable storage medium for storing computer instructions, wherein the computer instructions are configured to cause a computer to execute:
for each flow in the flow training data set, calculating a spatial-temporal feature of the flow by employing an initialized encoder;
obtaining a spatial-temporal feature combination of a source and a destination neighbor flow of the flow, and calculating a neighbor embedding of the flow by employing an attention network;
inputting the spatial-temporal feature and the neighbor embedding into a discriminator to calculate a malicious degree score;
calculating a difference between the malicious degree score and a flow label of the flow, calculating a gradient of parameters of the encoder, the attention network and the discriminator relative to the difference, updating the parameters of neural networks to obtain trained neural network models corresponding to the encoder, the attention network and the discriminator respectively, and recording a threshold that enables the flow training data set to achieve a balance between an optimal recall rate and a false positive rate, wherein the neural networks comprise the encoder, the attention network and the discriminator; and
calculating a malicious degree score of a flow to be detected by the trained neural network model of the discriminator, and comparing the malicious degree score of the flow to be detected with the threshold to determine whether the flow to be detected is a malicious flow based on a numerical comparison result.
